(19) United States
(12) Patent Application Publication
(10) Pub. No.: US 2013/0040022 A1
(43) Pub. Date: Feb. 14, 2013

(54) REFRESHED FRUIT AND PRODUCE BARS

(71) Applicant: AHMAD AMIRI, RICHMOND HILL (CA)

(72) Inventor: AHMAD AMIRI, RICHMOND HILL (CA)

(21) Appl. No.: 13/252,822

(22) Filed: Oct. 4, 2011

Related U.S. Application Data
(63) Continuation of application No. 12/131,462, filed on Jun. 2, 2008, now abandoned.
(60) Provisional application No. 60/975,469, filed on Sep. 26, 2007.

(51) Int. Cl. A23B 7/02; B65D 81/18; A23L 3/3454; A23L 1/212

(52) U.S. Cl. 426/127; 426/615; 426/138; 426/106; 426/532; 426/618; 426/634; 426/640; 426/392; 426/415

(57) ABSTRACT

The inventions uses preferably dried fruits, makes them ready to use, by chopping, mixing with other fruits and/or produce, fortifying them, forming them into bites and/or bars, wrapping and packing them to make them easy to transport, store, shelf, label, purchase, carry, keep at home, carry in pocket, hold in hand, eat, with little waste or disposal, little or no need for refrigeration, etc. Also a method of moistening dried fruits to make them taste similar to fresh fruit, and fortification to increase nutritional value and other treatments are introduced. A substance laced fruit is introduced to promote fruit and enhance nutrition.

### REFERENCE TO PRIOR APPLICATIONS

This is a continuation of U.S. application Ser. No. 12/131,462 filed 2008 Feb. 6, also claims priority of U.S. Provisional Application No. 60/975,469 filed 2007 Sep. 26.

### BACKGROUND

Some reasons why People need convincing to eat Fruits are listed below. For better visualization, compare each issue with comparable issue for Chocolates or Chocolate Bars. Then it becomes clear why consumers are Fruit Averse. Here are some of Issues with Fruits:
Transport, Storage, Refrigeration, Packaging, Spoilage, Disposal, Waste and other issues at every stage from farm, shipment, storage, shop and home make them very expensive. This issue should be multiplied many times for its negative impact.
An example of Waste is that many grown and good fruits have to be dumped just because they do not have standard shape or size for consumers eyes.
Consumers have little indication of fruits taste and quality, other than its look and size, which often betray the consumer. It is often a hit and miss decision when.
Many fruits in groceries are not tasty, when compared to ripened ones are picked from in the farm. They are picked unripened, then artificially ripened in transport and storage, deprived of soil nutrients, sun and the tree host.
Little uniformity and predictability of taste and quality.
No way of labeling nutritional content, as each fresh batch is different.
Variety is hard to achieve, yet necessary, as no single fruit does it all and variety is essential. Consuming a range of fruits means a consumer, who in todays society is often a single person or couple, having limited time and fridge space needs to perform said difficult decision, at least twice a week, yet buy only a minor amount of each, coming home with more bags than food.
Carried by few shops, not in good variety by gas stations, corner shops, newsstands, etc.
Bulk storage at home is impossible. Frequent buying is a must.
The most difficult or impossible to order for home delivery, both because no standard description of each fresh produce and due to lack of an outdoor fridge for delivery truck to leave it in.
Unpacking and fitting into limited fridge space is an undesirable task.
Even noticing what is hidden in the fridge is not easy.
Fruit gets placid and dry in the fridge.
Fruit out of the fridge is too cold, compared to natural farm picked, and for winter appeal.
Refrigeration negatively affects quality, nutrition, taste and appeal of fruits.
Once out of the fridge, fruits rot faster than they are typically be consumed.
Handling fruit out of kitchen, say in car, street, shops, office is not practical, often impossible.
No easy way of carrying fruit in pocket, bag, car, desk or many other places of need.
Peeling is not what we look forward to, especially out of kitchen.
Disposal of skin, seeds, kernel, when out of kitchen is problematic.
A peeled fruit, if half eaten, is wasted, leaving guilt behind.
Special bowls are needed to hold fruit while being consumed. Bowl, knife & fork need washing too.
Holding in hands is unpleasant, especially when trying to do some work or keyboarding.
Washing hands and face is a necessary burden, but difficult or impossible out of kitchen.
Serving fruit in a party is too complicated, for obvious reasons.
Fruits are often over filling but un-fulfilling. Eating an orange fills the stomach, but little fulfillment as compared to equal amount of meat or chocolates, by weight and/or price.
Nutritional density is low, because each fruit has some of needed nutrients, often at low density. Eating much of many fruits are needed for fulfilling, which is impossible and torturous.
Tooth enamel depletion is high when eating fruit, which is like chewing water.

The word Fruit in this application should be interpreted to include Vegetables and other Produce, to the extent it makes sense to the skilled. Many of above apply to Vegetables and/or other Produce.

### SUMMARY

This Invention identifies a number of problems in handling and consuming Fruits and other Produce. Then resolves many such problems to make a range of Fruits and Produce that are almost as easy to handle and consume as chocolates are, more nutritious and tastier than untreated fruits, much cheaper to transport, store and shelf, and other advantages, which may be called Super Fruit.
It teaches a number of Enhanced Fruits, one may be called Joy Fruit. Also many techniques for fortifying, packing, moistening, storing and other treatment of Produce, plus some relevant appliances. One method uses cold water vapor or other liquid vapor, mixed with air or other gas placed or passing around the produce or through fresh and/or dried produce pile to achieve moisting, cooling, preserving, cleaning, disinfecting, fortifying a produce and achieve other results.
The general idea is to make fruits as easy to handle as say chocolates bars are. Each serving to contain many fruits, which are fortified for extra nutrition, and cheaper than past.
In particular, fruit is ripened, peeled, kernel removed and dried, then moistened, fortified, mixed with many other fruits, formed into bars, wrapped and packed in packages that maintains their moisture and preserves them, even without refrigeration, hence as easy to carry, hold in hand and eat, and much more nutritional than a comparable amount of fresh fruit by price and/or weight.
Such reformed fruit resolves all of above mentioned issues with varying degrees of success.

### DESCRIPTION

Various techniques must be described, various combinations and/or permutations of which techniques will enable the skilled to make and use the products, methods and machines introduced.

### A Method of Moistening, Cooling and Fortifying Produce

To keep fruits, vegetables and the like, collectively referred to here as Produce, from rotting, one conventional method is refrigeration, which has at least the following disadvantages:
reduces ambient moisture drying the Produce
wastes much cold each time the fridge door is opened
requires cooling at low temperatures which reduces nutritional ingredients
requires cooling the entire space containing the Produce, say all of the fridge interior.

Another method used in retail stores is to sprinkle a pile of Produce with usually cold water, which has at least the following disadvantages:
needs cooling of much water
saturates the Produce with too much water
washes away many nutrients
only penetrates the external layers of a pile
is practical only in retail stores, not home, warehouse nor transport trucks
cannot be easily automated.

Some of many ways of generating water or liquid vapor are a) heating b) creating a vacuum to reduce boiling point of the liquid, c) forcing the liquid through a specially designed nozzle, s.a. fuel injection and carburetors, d) laser vaporization, e) etc.

In this application distinction is made between “gas”, “steam”, “vapor”, “sprinkle” and “liquid”. All and each referred to by general term “media”. Gas has reached phase change in the implied or specified operating temperature (e.g. air and nitrogen are gases even inside a fridge). Steam, has reached phase change, is hotter than most of our operating temperatures, but at lower temperatures inside a fridge will liquidate. Vapor appears like a dense gas or fog, but is made of tiny liquid droplets, has not reached phase change. Sprinkle is liquid droplets which are too large to behave like a gas. Gas, Vapor & Steam, each and all called “floating media” float in space while non-float Sprinkle and Liquid fall down. The “substance ” of all media is not limited to water, but may be oil or other.

A very practical, simple and cheap method to generate vapor, is to place in a liquid, piezoelectric element(s) that vibrate at high frequency when subjected to electric current, vaporizing the liquid. The liquid need not reach gas temperature (or go through a phase change from liquid to gas), but is agitated into tiny droplets of liquid. Said elements can be made not to release undesirable odor or chemical with the vapor. Amount of vapor, size of droplets, temperature, etc. can be controlled. Methods above are each useful to various degrees for the kind of use we can make of them. E.g. steam can be used, instead of vapor where its heat and condensibility is not an issue.

Produce, in this application is the general term for:
A—fruits, vegetables, herbs and the like which are consumed largely fresh
B—nuts, grains, legumes, seeds and the like, and products from them such as bread
C—meats, cheese, yogurt and the like
   Keeping Produce Cool and/or Fresh

In one version of the invention, cold water vapor is placed so as to touch the Produce, keeping it cool, fresh and moist. Produce is partially or totally surrounded by liquid vapor instead of by liquid. Compared to refrigeration this uses much less energy as only the space around the Produce, not the whole container need have vapor, prevents drying of Produce, can keep Produce moist and fresh at higher temperature than cold storage, hence less nutritional depletion and less cooling costs. Vapor like fog or mist is slow moving, and does not easily fly out of the container even if opened.

It also eliminates or sharply reduces each of disadvantages of sprinkling. In particular, its use is not confined to retail facility. Used inside a conventional refrigerator which preserves Produce from rotting, this invention can add a number of values mentioned before or hereafter, such as preventing drying. Said conventional refrigerator can be a home appliance, retail refrigerated shelving, refrigerated container or truck, commercial cold storage, etc. As the liquid is vaporized at low temperature, it does not readily liquefy under cold fridge condition, but remains in vapor form for much longer than steam or other liquid gasified by heating.

This method cools by both using cold liquid vapor and moisting. Note that even moisting by lukewarm liquid has cooling effect, let alone moisting by cold vapor. Thus the need for conventional machinery to cool the Produce is reduced or eliminated. A fridge can use this system alone, or use a relatively simpler cooling device to cool the water and/or other liquid before and/or after it is vaporized. Typically, the vapor will have some air in it but most methods of generating vapor can be modified to reduce amount of air to desired or insignificant level. For example, the liquid container piezoelectric system can have no or little air to start with. Also pipings can be sealed not to let air in. Any vapor outlet can be equipped with means, such as valves, not to let air in when letting the vapor out.

Gases other than air can be mixed with vapor and/or used intermittently with vapor and/or used without vapor to achieve certain results, such as disinfecting. For example, an inert gas such as nitrogen can be used to fill the Produce container, forcing air out, to deprive any organism of oxygen. Germicide gases are another example of many desired results that can be achieved.
Each vapor and/or steam and/or gas can be and or carry one or more “agents”, examples:
Germicides, Fungicides, Microbicide and/or other Disinfectants
Vitamins, Minerals, Anti-Oxidants and/or other Fortifications
Sugar, Salt, Lemon, Vinegar, Mint, Essences and/other Taste or Property Enhancers
Anti-Oxidants and/or other Preservatives
Fragrances and or other Scent Enhancers
Other agents such as Hydrogen Peroxide, Ions, etc., as desired

More than one substance can be used, say water and oil. Different substances can be used mixed and/or intermittently. Mixing of such substances can be before and/or after vaporization.
Gases can be Ionized themselves (as an alternative to carrying Ion agents) for different effects. Delivery of gases, vapors and or agents can be controlled to suit absorbing capacity of the Produce or other yardstick, so that once absorbed by outer skin of Produce, it has time to move to inner layers not to soak the outer skin. Delivery of agents via gas, vapor or steam can be applied independent of cooling and/or moisting.

Liquids instead of vapor or gas can also be used to delivering such agents to Produce, but with many disadvantages, such as:
uniform delivery of an agent into a Produce by typically requires submerging the Produce in the agent bearing liquid or running the liquid around it, both dissolve some of nutrients out of the Produce,
control of the amount and rate of absorption is very difficult,
uniform delivery to various sides of a unit of Produce, say an apple, is more costly and/or difficult,
uniform delivery to various segments of a pile of Produce is more costly and/or difficult,

For faster and/or more uniform delivery of gases, steams, vapors and agents in them to a Produce, many techniques and various combinations and permutations of one or more of said techniques, each suiting some circumstances, can be used. Some such techniques are:
for each layer of Produce in a tray, spreading each unit of Produce distant from other units
reducing or avoiding multi layer stacking in each tray
racking each tray at a distance from the adjacent tray above and/or below it
using net like floor for the trays to increase Produce exposure to media
using upright spikes based on the tray floor with tips holding the Produce above tray floor
increasing flow of media around the tray using pumping, convection and/or other methods
increasing pressure inside the container that holds trays which hold the Produce
increasing the temperature of the media, even using steam where appropriate
moving the Produce to change its surface of touching the media, by stirring, shaking, spinning, etc.
helical displacing and/or other methods of mixing say liquids with solids
moving the trays in the media, and if needed adding lids to trays to prevent Produce spillage
all conventional methods such as shaking and tumbling the Produce

One interesting feature that can be achieved using vapor, steam or gas, is mixing substances that do not mix as liquids, say water and oil. Each can be converted to vapor or steam separately and then mixed. Alternatively they can be put in same container and converted to vapor or steam, and stirred and/or shaken if needed. Such mixture can be applied to Produce for cooling, disinfecting, etc. Water is one of the best of many substances for many of our purposes. It is odorless, tasteless, edible, cheaply and readily available, a natural component of most Produce, easily convertible to solid, liquid, vapor and gas, dissolves and harbors many agents, etc.
Solid fine powder can also be made to behave like vapor and used for our purposes. For example, powdered solid carbon dioxide (or dry ice) can be blown and deposited onto Produce for cooling, especially where the container is not sealed and the gas form of same substance can escape. Another example is calcium fine powder blown over a Produce for fortification. Ditto for disinfecting, etc. Any excess of vapor need be removed and or pumped out, whether the excess is in liquefied vapor, steam gas, or settled powder. Containers in which Produce is held should be designed to collect excess liquid or powder and remove it. Also, sprinkling systems used in Produce retailers to freshen Produce can be automated for use in delivery containers, trucks, warehouses and home fridges, even if vaporization is not used. Liquids can also be used to achieve many of the above sought results.

### Fortifying and Treating Produce (Especially Dried Versions)

Techniques herein to keep Produce fresh and/or cool can also freshen and moist dried Produce. Floating media was a preferred method for cooling and preventing dehydration. For this section, moisting dried Produce is a major goal, and can be done by non-float and better floating media.

However, moisting a solid with a liquid can often be done more controlled and better by floating the liquid first. This has applications in many industries beyond food. E.g. stirring a pharmaceutical powder in a container of water vapor or steam will moist it more uniformly and controllably than conventional mixing with water or even sprinkle.
One major problem with many fresh Produce in shops is that they do not taste as good as they should and do on a farm. Fruits are harvested “unripe”, to ripen during long refrigerated transport to shop. Such artificial ripening is deprived of soil, water and sun, all important for a tasty and nutritious fruit. Ironically, people have to be convinced to eat fruit while naturally ripened ones are irresistible. Another disincentive for consuming fruits is handling. They need to be kept in a fridge, difficult to carry in a bag or pocket, often need peeling and cutting, messy for hands and lips, etc. By comparison a chocolate bar has none of the above issues. Besides, transporting fresh Produce is costly.
All said problems can be solved by drying the Produce before shipping. Drying may reduce some nutrients, but so does refrigeration. Some drying techniques, such as vacuum drying, preserve most nutrients as no heat or cold is applied. The drier the better for transport, reduced rotting, shaping, say to a bar, chopping to smaller chunks, mincing and even powdering.
Another advantage of dried fruit is denser amount of sweets and nutrients per serving. Some fresh fruit taste deficient in sugar and other ingredients, causing fruit aversion in consumers. While having variety of fresh fruit is difficult, mixing varieties of dried Produce even in one serving is easy, especially when dried Produce is cut to small pieces. For example, dried powdered fruits can be mixed in many ratios. However, dried Produce does not taste fresh and moist and is often too difficult to chew or swallow. Techniques described here can be used to moisten and freshen dried and fresh fruits before using. They can also be used to fortify Produce with much of nutrients it looses in drying, and more. Disinfecting and neutralizing negative substances in new ways are also introduced.

One example is bread, to be made crisp and dried, then moistened before consumption.
Moisting just before eating, with steam instead of cold vapor, will also warm the bread.
Above also facilitates consumption of bread made of legumes, which have less starch and more protein than carbs. Typically made crisp and dry, they can be moisted and/or warmed before eating. Mixture of Grains and Legumes can make a bread which is more easily softened and moisted. Difficulty with making legumes bread is being brittle. Adding grain fiber helps, but adds carbs which may defeat one object of having no carbs. This application suggests adding long veggitable fibers, such as parsly stems to legumes powder or flouer. Parsely or similar stems, when dried can be ground into strands holding legumes particles together when baked.
Moisting nuts, makes them taste almost as good as fresh nuts off the plant. Preferably, care should be taken not to flood nuts, fruits, vegetables, etc beyond saturation, as it may remove some nutrients. With floating media, it is easier to control the moisture and prevent over saturation and loss of nutrients. Above can replace roasting and salting, as dry nut can be fortified with salt dissolved in the media, even at home, to suit consumer taste. Ditto for other fortifications, disinfections, etc.
Moisting provides a range of new preparation for eating dried Produce. For example, we can moist grains s.a. wheat to make them edible, just like before they are left to dry on the plant for harvesting. Ditto for legumes, nuts, etc. Moisting can be done also after the Produce, especially grains and legumes are heated, roasted or cooked.
Also dried nuts and/or other Produce can be fortified with agents such as salt, lemon, etc., then dried for easier storage, longer shelf life and transport. Such agent loaded dried Produce can be moisted before use. This treatment is superior to roasting which reduces some nutrients, deposits agents mainly on the surface (not deep into Produce) and is difficult to control.

Some Produce have a hard to eat skin, e.g. due to high fiber levels, a plus in itself. Once dried, some become edible, e.g. due to breakage of long fibers. Also skins taste can be improved by fortifying as explained. Optional remoisting often further eases eating of said hard to eat skin.
Drying some fruits removes some unwanted elements. E.g. skin of some fruits has health benefits. Undesirable taste of such skin can sometimes be removed by drying to evaporate such taste. Other parts of Produce, such as seeds inside melon is not pleasant to eat fresh, but once dried, especially if treated (salted, fortified, etc.) become tasty and nutritious. Thus even a home appliance can be made to wash (if necessary), dry, even fortify, seeds for eating (not disposal).
An important implication of making skins, seeds and/or other parts of Produce edible is that some messy and unwelcome steps of eating Produce, such as peeling and chopping can be ready made. This makes the difference between eating or avoiding fruits for some busy persons.
Wherever moisting is suggested in this description, it does not have to be in a time or position close to consumption, say at home, but where and when it makes sense. In particular, many consumers may not bother with moisting and rather have their Produce ready to use, similar to chocolate bars.
Also, wherever term “dried ” or “dry ” is used in this description, it does mean having no moisture, but moisture content is below fresh state to suit the sought result. Moisture need not be water but any substance(s) that provide sought results.

Some of many “forms” dried Produce, especially fruits can take are:
Whole, s.a. whole plum or whole almond, in various packaging, including bulk
Bars, preferably wrapped, like chocolate bars, that can be moisted in many ways
Slices, that can be quickly moisted, by soaking or otherwise, preferably paper or ploy wrapped
Chops, in many forms of packaging, including bulk, preferably in pocket, purse or handbag size, sealed or unsealed packets, to eat dry or moisted (say in a glass), before consumption
Powder, which in addition to other forms of packaging, including bulk, can be in sacks (even for pocket or purse), like chocolate powder, to be consumed as powder, mixed with hot or cold water or other liquid such as milk) to form a hot or cold drink, mixed with enough liquid to form a pulpy paste, even mix with food such as yogurt, etc.

Bars and slices can be made of smaller pieces of one or more Produce, say cherry and apple. Loosening of such assembly, especially during moisting, it can be prevented by skin wrapping in edible material such as starch, leafs, sea-weed, etc., which if not permeable enough for required moisting speed and ease, are perforated or made like a net.
An outer synthetic skin wrap which is rolled down or removed to allow moisting and rolls up or put back on the bar will allow clean holding by hand for eating, or even zip locked for carrying.
One type of synthetic wrap has three layers, the inner one rests on and holds the bar together, the outer layer touches and is held by hand, and the mid layer keeps the outer and inner layer a distant apart so that the holding hand does not touch the inner moist bar. All layers are perforated, preferably not aligned with perforations of adjacent layer(s), so that even though ambient moisting media can reach the bar inside, bar moisture does not touch the holders hand. One way of achieving said three layered wrap is using corrugated and/or flute looking wrapping. Said 3-layer wrapping or packet can also be used to hold whole, powder, chop and slice forms together for carrying, holding and eating. Packets holding dried Produce, in any of forms described here or other forms can have additional compartment(s), each compartment holding one or more liquids. Hand pressure or other techniques releases the liquids into the Produce compartment to moist it. Thus the Produce is dry for storage and even pocket transport, but can be moisted for use on the go.

Said packets can be pocket or other sizes. They can have zip-lock for transport, even when moist. Said packets can be made disposable but preferably reusable, main compartment of which can be filled with one or more dried Produce, especially fruits, and other compartments can be filled with water and/or other liquids. Means, s.a. valves that release said liquids should be made like a form of tap, to be opened and closed for multiple uses. Said apparatus can also be made in box form.
Produce can be made premoisted and sold in packets, packs, bags, jars, cans, barrels, etc., preferably sealed and/or vacuumed, refrigerated if needed. Produce, especially fruits can be allowed to ripen (rather than picked unripe), dried, shaped to more usable forms like powder, chop, slice, bar, etc., moisted, disinfected, fortified, etc., and packaged in packets, packs, or other packaging for sale. Transport can be before moisting, to save problems of shipping fresh. Transport, even after moisting of such repacked Produce is much cheaper and easier than fresh Produce. To reduce or eliminate any need for refrigeration of remoisted Produce, preservatives can be added. Retail of remoisted Produce is easier than fresh ones. Consumers will find it easier to purchase, carry, maintain and consume. Moisting each unit (whole, slice, bar, etc.) of Produce can be done in two or more layers. E.g. water allowed to sink deep into the unit, then moisted by edible oil on the outer layers, preventing the more inner liquids from escaping and drying, and even a third layer depositing a starch skin.

Depositing a thin layer of an edible but less porous skin over each unit of Produce can prevent drying. Such layer can be starch based, sugar based, cellulose based etc. Some forms such as slices, bars and wholes can be skin wrapped, with edible or inedible skin.

Submerging moist Produce in “jelly”, which is in turn in a packet or other container, prevents drying.

Such jelly can be removed before consumption or eaten with the Produce.

### Needed Devices and Machinery

Devices and Machines to perform methods and techniques hereby can be made, by assembling components, each of which to perform one or more of the steps. Method and techniques here define the devices and machines, which can be made in many different formations. Such machines and devices can be made for household, office, container, transport, warehouse, store or elsewhere. Machines can have means to gauge various measures, such as amount, density, heat pressure of the media applied to cool, freshen or moist the Produce, amount of moisture absorbed by the Produce (perhaps by inserting a tip), amount of any disinfecting, fortifying or other agent in the media, etc., other components to generate floating media, contain the Produce, remove excess floating media, remove excess non-float or condensed media, etc., other components to pack and do other steps of the techniques and methods explained here.

### Some Preferred Embodiments:

Practical Mulberry: In many parts of the world, people have never eaten mulberry, a very tasty and healthy fruit, yet too difficult to transport as it looses taste and character in freezing, refrigerating, canning, etc. It is very delicious when dried, and regains most of its original taste when remoisted. When dried, it can be transported to far away consumers and stored for long periods. It can be moisted by mixture of water and property enhancing agents (to enhance taste, nutrition, punch, color, mood, etc.), packed in sealed packets, allowing it to be shipped, stored and shelved for long enough to be sold to consumers. Consumers can then carry the packets on the go or eat it at home. If desired, they can dry it to reduce moist to their liking, then eat dryer, even remoist it if over dried.

Ready Meat: Cooked meat can be fully or partially dried, then impregnated by liquid solution of preservative or preferably a liquid which is a preservative itself, as apposed to solving a preservative agent. Said liquids better evaporates easily when exposed or heated lightly. Meat is then bagged in packets, packs, jars, cans or other preferably zip locked or sealed packaging to retard evaporation of said liquids. Meat will be ready to use, but preferably should be dried by air, oven or barbecue to loose most or all of its excess liquids, then if need be remoisted for eating.

Healthy Meat: Meat can be soaked in a fat dissolving liquid for long enough to dissolve much of its saturated fat. This step is more effective if meat is minced, chopped or sliced. Also more effective if the meat is first dried, as it then absorbs more liquid. Then most of fat is drained along with solution, if necessary, by pressure, centrifuging, toweling, dipping in moister absorbing powders such as salt or flour, other available methods and combinations. Such meat, can be remoisted with desired amount of unsaturated healthy fat and fortified as desired. This process better be applied to raw meat. Such fat reduced meat can then be dried more easily for preservation. Result is a meat upon which other processes, s.a. those introduced here, in particular ready meat can be applied. One suitable edible fat solvents is lemon juice, but others are available. Even non-edible or less healthy fat dissolving liquids can be used, so long as it can be evaporated out of meat.

Injection Gas into Produce

Injecting gases, such as carbon dioxide or even air into Fruits would add some exotic taste, in same way that injecting gas into water does. This is not so easy with fresh fruit which is water saturated and may go placid if even more is injected into it. But dried fruit is naturally absorbent. Some ways of injecting gas into dried or fresh fruit are:
moisting it with gasified water or other gasified liquid, which liquid may be in vapor form, in a pressured container that would maintain gas inside the liquid or vapor,
keeping it in a pressurized gas chamber for some time, which time depends on the gas, fruit and how moist it is. In many dried fruits, moisting below saturation helps gas absorption.
Storing gasified fruit would require containers which disallow gases to escape, such as sealed jars, cans, bottles mostly developed for carbonated beverages such as coca cola.

### Pressure Aided Impregnation

Pressure chamber or ambient pressure can be used to inject certain ingredients into produce, which due to viscosity, particle size or other factors resist absorption into semi dried fruit at normal atmospheric pressure.

Radiation: Electron beam or other radiation can be used to increase shelf life of moisted dry fruit.

### Some Desirable Properties for a Moisturizing Media:

L—liquid, hence moisting effect to moist dried Produce, especially fruits
P—preservative, even without any preservatives dissolved in it
D—disinfectant and/or germicide and/or fungicide even without agents dissolved within it
E—edible in case deliberately or inadvertently left unevaporated in the Produce it has moisted
Q—quality preserving, with insignificant detremental effect on produce's desired qualities
I—inherently having said properties, wether or not an agent is desolved in it
U—other than water, as water is a source of produce spoilage
G—gas or evaporating, if heated or even exposed, so partially or totally escapes the produce
N—nutritional and/or medicinal properties
T—tasty to some or all consumers
M—mood, punch, effect, and/or other properties altering positively for some or all consumers
S—solvent, can dissolve lipids, disinfectants, essences and/or other agents
Note: In view of numerous substances known to the skilled with a number of desired properties, in this application, we may use acronyms for a substance, using above capital letters. For example MSG has at least above properties M+S+G and more. A skilled is able to identify a number of such substances. Media need not have all said properties. Substances with all above exist too, some with side effects. Some Enhancers: Examples of agents to dissolved in a media, to enhance fruits properties are:
cumin essential oil as preservative
mint, pepper, cinnamon, ginger for punch
chocolate and substances used in coke for mood enhancing
vanilla, salt and honey for taste
vitamins, minerals, calcium for health properties
lemon, lime, vinegar as fat desolates, that may dissolve bodily or coronary fat deposits
essences and fragrances such as rose for odor
Co2 gas for effect
grape seed oil for sealing the external skin to reduce moisture evaporation
One agent can have many properties beyond what is in above example.
Example: impregnating dried grapes (raisin) moisted with water containing cumin essential oil, mint, chocolate, vanilla, calcium, lime, rose, Co2 and then soaked in grape seed oil to keep it moist. Resulting moisted raisin will last longer, and have many extras not found in raisin alone.

Joyfruit: Using a LPDETM Substance, to be called Joyjuice as one of a number of substances for moisting dried or fresh produce, various combinations and/or permutations of one or more of techniques in this specification, gives many useful results listed below: (In view of multiplicity of positive criteria required of Joyjuice, we assume some such Joyjuice may have negative properties, especially if consumed above a safe limit):
Joyjuice serves as a preservative, reducing and even eliminating the need for refrigeration, especially if wrapping and/or packing prevents evaporation of Joyjuice
Joyjuice itself has some health properties, when consumed in moderation, which moderation is made possible here, by adding fruit and reducing Joyjuice
mixture of Joyjuice and produce, say fruit, can have health effects beyond that of each
it enables consumers to consume Joyjuice along with healthy food, without extra time or effort
it provides taste enhancing of fruit
if percentage of Joyjuice is low, it may not be subject to legal restrictions, enticing consumers to change their habits to consume healthy produce, say Joyfruit fruits, nuts etc., instead
Joyjuice injected as a small percentage of total weight into produce, need not be over healthy limit
if water is substantially removed, and/or other means of preservation are applied, the Joyjuice for preservation can be low enough even for child consumption. Foods naturally may have Joyjuice
Joyjuice in produce is absorbed slower than consuming it alone, giving the body time to metabolize
Joyjuice taste, for those who like it, is provided in a setting that is hard to take too much
Joyjuice used for preservation, can be evaporated in open air or oven, to desired low level. Thereafter remoisting techniques can then be used optionally.

Joy fruit example: In many parts of the world, people have never eaten mulberry, a very tasty and healthy fruit, because it is too difficult to transport, looses taste and character in freezing, refrigerating, canning, etc. Yet it is very delicious when dried, and regains most of its original taste when remoisted. When dried, it can be transported to far away consumers and stored for long periods. It can be moisted by mixture of Joyjuice and water, packed in sealed packets, allowing it to be shipped, stored and shelved for long enough to be sold to consumers. Consumers can then carry the packets on the go or eat it at home. If desired, they can dry it to reduce Joyjuice, then eat dry or remoist it.

### Various Other Techniques for Treating Produce:

Preserving with MPDEG

Impregnating produce, especially fresh or dried fruit with LPDEG kills many germs that cause rotting, for as long as MPDEG level is sufficient, which varies for different produce. LPDEG may reduce water evaporation, keeping the produce moist, substantially reducing refrigeration. LPDEG can be consumed with produce or allowed to evaporate prior to consumption. Other agents can be added during impregnating. In fact LPG or LDG are sufficient for preservation.

Impregnating is by way of exposing the produce to LPDEG until it absorbs sufficient LPDEG. Methods discussed to reduce soaking and release of produce ingredients off the produce, such as Vapor can also be used. MPDEG may be pure, mixed with water, other liquids or agents.
Produce can also be cooked or uncooked meat or preparations such as sausages.

### In Package (Bag) Impregnation

Impregnation can be done by injecting or providing some MPDEG and/or other liquid(s) and if required other agent(s) into the package, such as a jar, can, sealed bag, sack or wrap, barrel, etc. which contains the produce.
To prevent produce soaking and over saturation, an absorbing mass, such as a sponge or powder should be in the package to mop up extra liquids. Volume and said mass can be chosen of a size, material and weight to absorb extra liquids and even release them when the package's inner space becomes too dry, say due to temperature change, preventing produce from drying.
If said sponge touches the produce, it may transmit more liquid into the produce than is acceptable. A porous un-absorbing barrier such as a net, placed inside the package to keep the absorbing mass apart from the produce.
Absorbing mass can be edible, such as cooked rye stick. Another is legumes powder in a perforated, preferably edible sack. Thus any nutrition lost to excess liquid is collected for consumption.

### Produce Adhesives

Produce, especially fruit, better be in manageable chunks, such as bites or bars. Often it should be broken into small bits and then formed. An adhesive is needed for integrity of the form. One ideal adhesive is edible tree sap. Other edible glues can also be used.

### In Package (Bag) Evaporation of LPDEG

LPDEG residue in produce beyond an acceptable level, say 0.5%, may classifies the produce as unhealthy for many and requiring license to sell.

Consumers dislike waiting hours to air the produce to evaporate excess LPDEG. One solution is that the package is made larger than the produce inside it, so that LPDEG in the produce, say used for germicide, escapes into its vacant space, but remains in the sealed package killing any ambient germs, preventing rotting. Not only the produce is sanitized, but recontaminated by is controlled. Sealed bags are the preferred packages for this purpose, as large rigid jars are awkward.
Other germicide gases can be used in the package as preservative, without fruit impregnation.

### Fruit Capsules

Fresh or dried fruit or mixture of many fruits can be kept in edible capsules, such as capsules used for medicine. A variety of edible packaging and wrapping films and skins are known to the skilled. One example is made of protein milk casein with water and glycerol. Another is polyactic acid film. Such films can contain antimicrobial agents such as nicin. Such films can be made as capsules or tea bag like sacks.
Capsules need not be edible, but burst open by finger or teeth pressure to release the fruit. Capsules can be added to each other to form a bar.

### Vegetable Bars

(example) Many veggies, such as Brockley, are not so appealing to many. Cooked veggies are often more nutritious due to higher human absorption of their nutrients. If fortified say with salt, lemon, pepper, etc., become delicious. Consuming a variety of veggies is difficult as each need their own preparation. Techniques introduced here enables making sacks or bars or one or more veggies, wrapped preferably in edible skin or capsule, ready to carry and eat without messing.

### Adding Filling & Bulk

A major turn off of many fruits is that unlike say meat, one feels hungry after eating them. Adding fibrous bulk to fruit to create a mix, paste, doe, etc to make a bar largely solves this. Examples of fibers being rye bread, cooked dried legumes, dried vegetables, in powder or particle form. Fresh fruit squashed, then mixed with such fiber formed into bar gives a filling mix. This dries up the fruit without heating which can deplete some ingredients or without vacuuming which is costly.

Ideal fruits for this purpose are those that do not lend themselves to drying, such as water melon. Moisture content in the mix can be reduced by increasing fibrous bulk, so that the mix has a shelf life comparable to dried fruit. If necessary adhesive agents can be added to the mix. The result can be used in many forms such as as jarred paste, wrapped bite or bar, dried or fresh. Also techniques used to preserve and treat dried or fresh produce for shelf life or other reasons can be applied.
For example, MPDEG is added to the mix to kill its germs. It is formed into a paste or bars, and vacuum packed. Alternatively the paste (or bars in a porous wrapping) are placed inside a bag, nitrogen packed in the bag. Bag is large to allow MPDEG to escape the fruit fiber mix, but remain in the bag to prevent recontamination.

### Reducing Produce Water Content

In many of our methods and products, produce can be dried in the process rather than using dried produce. For example, rather than using dried fruit and moisting, fresh fruit can be dehydrated. Other steps, such as fortification, chunking and packaging can be applied to moist but not fresh produce.
Helpful Preservation Techniques: Nitrogen Packing, Vacuum Packing, Radiation can be used as alternatives or in conjunction with some of the techniques here.
Moisture Maintenance: is also possible by adding moisture maintaining agents such as Glycerin. Making Produce Ready To Use: Peeling, removing seeds and kernels, cutting to manageable bites or sizes, coloring, salting, sweetening, etc can be added to the techniques here.

### Produce Cooling & Moisting Appliance

This is an cabinet, similar to a fridge, insulated from ambient (say kitchen) temperature in which produce are kept, cooled and moisted by cool water vapor. It can be a compartment of a fridge. Trays inside are designed to have least contact with the produce they hold to allow maximum contact between the produce and the vapor that is to surrounding it. Some ways of doing so are for the trays to have a spiked produce holding basin, which is made of wire mesh or spiked (as explained), both of which basin forms can be like removable boards or mats lying over the tray's solid basin, which mats can be removed for cleaning (the tray and the mat).
Tray basins, if solid and the cabinet, have channels to collect and dispose of any liquefied vapor. A vaporizing device or devices vaporize water and/or any other liquid. Cooling device(s) cool water and/or and/or other liquids, before or after they are vaporized. Heating devices heat up the vapor if and when too cold. All aiming at a desired vapor temperature.
Fans direct the vapor to surround the produce. Other Fans remove extra vapor. Gauging devices measure the temperature and vapor density and prompt injection of more or removal of excess. Optionally, vapor or ambient air pressure can be controlled by pumps and release valves.
Even nitrogen can be pumped in to replace oxygen to reduce oxidation.

The Cabinet can have different compartments for different produce. Vapors can be channeled via pipes and valves to different compartments. Each compartment if equipped with own gauges, can crate its own internal temperature, vapor density, pressure, etc. for different produce and tasks.
A manual or computer controller can regulate the timings, type, density, pressure, temperature, etc. of each vapor to each compartment. mixers can add various agents to liquids before or after vaporization. One advantage is that vapor is so manageable as to density, pressure, temperature, type, etc., that absorption into the produce and or brushing just for cooling can be controlled. These factors cannot be so easily controlled by liquids or by conventional refrigeration.
Fresh produce can be first exposed to disinfecting agent vapor. Then water for cooling and moisting. Vapor density to be so low as to touch the outer skin of produce, with little absorption.
Or a mixture of disinfectant and water can be vaporized and circulated. Water vapor density and pressure to be kept low to avoid soaking and over saturation.
Dried fruit can be in the same cabinet to be moisted. Bread dried for preservation can be left in one compartment (or a custom made unit) to moist, say over night, under warm vapor.
Dried produce such as fruit can be put in containers with weighting mechanism. Produce is weighted when dried and moisting is stopped when total weight shows enough moisture has been absorbed. Such container can have a helical, spiral, shaking or other stirring mechanism to stir the produce chunks as surrounded by vapor, so that moisting is evenly distributed.
Vapor circulated fast around fresh fruit can absorb, eject and dissolve residue chemicals on the skin of fruits with little absorption, as the speed of circulation is too fast for absorption of vapor into fruit. Said chemical laden vapor can be released out of cabinet. Same process with water washes some nutrients.
Said Appliance can be modified for trucks, containers, warehouses and retailers.
Retail version can be open top for customer access.

### Restating Some of the Description,

Some of the products and methods introduced are summerized below.
1—A mass of at least one type of produce, chosen from fruits and vegetables, where:
water content in each said produce is lower than its fresh state water level,
said mass is ready for consumption without peeling,
said mass is in a sealed retail package,
amount of any liquid and water in said package but out of said mass is insignificant,
when more than one type of produce, they are broken in small pieces and mixed together, and
most of any water in each said produce is induced and other than the water it originally had.
2—Above where said mass is fortified with at least one agent.
3—Above where said mass is broken into wrapped chunks, which chunk sizes are chosen from a list of bite size capsules, bite size sacks and bar size.
4—Above where said wrap is edible.
5—Above with means to control liquid and moisture amounts in the package but outside the mass.
6—Above using means to increase shelf life.
7—Above where the mass has at least two types of fruits.
8—A mass of at least one type of fruit, where:
said fruits are impregnated with a liquid,
said liquid is different from and in addition to any water the fruits may contain,
amount of said liquid inside said fruits is at least sufficient for a desired shelf life,
said liquid has at least the following properties: (p) preservative, (d) disinfectant, (e) edible, (q) quality preserving with insignificant detremental effect on desired qualities of said fruit(s), and (i) inherently possessing said properties wether or not any agents are dissolved in it,
amount of any liquid and water out of said fruit(s) but in same housing as the fruits is insignificant,
said mass is ready for consumption without peeling, and
said mass is in a sealed retail package.
9—Above where said liquid has at least one property chosen from (m) mood modifier and (g) gasifies and evaporates out of the fruit faster than water does.
10—Above where water content of said fruit(s) is substantially below their fresh state water level.
11—Above where said liquid content is low enough for general consumption without health hazards.
12—Above where said liquid gasifies and evaporates out of the fruit faster than water does, and said package has sufficient space to allow said liquid to evaporate out of said mass and remains in the package, where said liquid in the mass is reduced to a desired level.
13—Above where most of any water in said fruits is artificially induced and other than it originally had.
14—Above where said mass is fortified with a number of agents.
15—Above where said mass is broken into wrapped chunks, which chunk sizes are chosen from a list of bite size capsules, bite size sacks and bar size.
16—Above where said wrap is edible.
17—Above with means to control liquid and moisture amounts in the package but outside the mass.
18—Above where the mass has at least two types of fruits.
19—A mix, in retail ready packaging, of at least one fibrous, ready to eat produce broken into particle size, chosen from grains, legumes and dried vegetables, and at least one type of squashed fruit, said constiuents almost uniformly mixed, said fibrous content is enough to reduce water content per mix unit comparable to that of dried fruit, without drying or vacuuming of said constituents, whereby shelf life is comparable to dried fruit without use of damaging heat or costly vacuuming and the mix is fulfilling, tasty, nutritional and easy to handle.
20—Above where said mass is broken into wrapped chunks, which wrappings are chosen form edible and non-edible versions, which chunk sizes are bite, capsule, sack and/or bar size.
21—A method of extending shelf life and reducing handling costs of a produce by:
ensuring produce water content to be substancially below its fresh state water level,
above step is by acquiring the produce with said water content or reducing water content.
impregnating said produce with a liquid other than water,
selecting said liquid to have at least following properties: (p) preservative, (d) disinfectant, (q) quality preserving with insignificant detremental effect on desired qualities of said fruit(s), (e) edible, (i) inherently possessing said properties, wether or not any agents are dissolved in it, and
ensuring that water and liquid outside of the produce in same housing as produce is insignificant.
22—Above having the step of placing said produce in a sealed package, the volume of said package is such to allow a desired proportion of said liquid to evaporate out of the produce and remain in the package, where the liquid amount in the produce is at a safe level for consumption.
23—A method of manipulating temperature and/or liquid content of a produce, comprising the steps of:
providing at least one liquid,
providing means for vaporizing at least one of said liquids without substantially increasing their temperature,
said means creating fog like floating vapor(s), unlike escaping gas and unlike dropping sprinkles,
using means to keep said vapor(s) at a desired temperature, and
exposing said produce to said vapor(s),
whereby:
less liquid is needed than sprinkling,
hence less energy is needed for attaining desired temperature than sprinkling,
unlike sprinkling and submerging in liquid, almost none of produce nutrients are washed away,
unlike exposing to gas, less vapor is wasted to escaping,
one liquid can be water, maintaining moisture, unlike cooling in cold air as in a fridge, and
other liquids can provide a number of benefits such as disinfecting, fortifying, etc.
24—Above where a number of agents are added to at least one of said liquids, each agent to achieve at least one property, such as fortification, disinfection, preservation, taste enhancement, etc.
25—Above where at least one of said liquids is in gas form in said operating ambience.
26—Above with means to increase total surface contact of the produce with said vapors.
27—Above where the vapor pressure is at a desired level.
28—Above 23 where said produce is of dried form before being exposed to said vapors.
29—Above where said produce is dried bread, chosen from grain, legumes and grain mixed with legumes bread, said liquid is water, said vapor is maintained at a temperature to warm the bread for consumption, whereby bread can be dried for storage, transport and handling, then moisted and warmed for consumption.

1. A mass of at least one type of produce, chosen from fruits and vegetables, where:
water content in each said produce is lower than its fresh state water level,
said mass is ready for consumption without peeling any natural skin said produce may have,
said mass is in a retail pack,
amount of any liquid and water in said package but out of said mass is insignificant,
water content in each said produce is higher than its typical dried version water level,
said mass is produced from dehydrated fruits which is rehydrated,
most of any water in each said produce is other than the water it had when harvested or picked,
water level in said mass is enough to give a taste resembling fresh than typical dried form of same fruit,
almost all of any rehydrating water is remaining in said mass upon consumption.

2. Claim 1 where said mass has all ingredients and or qualities it would have lost if subjected to any of following for rehydration: (a) significant water loss during or after rehydrating, (b) subjected to heat above 50 degrees, and or (c) subjected to pressure above 3 atmospheres.

3. Claim 1 where said mass is broken into chunks, said pack is a wrapping.

4. Claim 1 where said mass is broken into chunks, said package is a wrapping, said chunk sizes are chosen from a list of bite size capsules, bite size sacks and bar size.

5. Claim 3 where said wrap is edible.

6. Claim 3 where said wrap is permeable allowing the edible produce to be rehydrated after being wrapped in said wrap and without removing the wrap.

7. Claim 1 where said mass is in a retail container with means to control liquid and moisture amounts in the container but outside the mass.

8. Claim 1 where:
said produce are impregnated with a liquid,
said liquid is different from and in addition to any water the fruits may contain,
said liquid has at least each and all the following properties: (p) preservative, (d) disinfectant, (e) edible, (q) quality preserving with insignificant detrimental effect on desired qualities of said fruit(s), and (i) inherently possessing said properties independently of any agents dissolved in it,
amount of any liquid and water out of said produce in same housing as the produce is insignificant.

9. A mass of at least one type of produce chosen from fruits and vegetables, where:
said produce are impregnated with a liquid,
said liquid is different from and in addition to any water the fruits may contain,
said liquid has at least each and all the following properties: (p) preservative, (d) disinfectant, (e) edible, (q) quality preserving with insignificant detrimental effect on desired qualities of said fruit(s), and (i) inherently possessing said properties independently of any agents dissolved in it,
amount of any liquid and water out of said produce but in same housing as the produce is insignificant,
said mass is ready for consumption without peeling any natural skin it may have, and
said mass is in a sealed retail container.

10. Claim 9 where said liquid has at least one property chosen from (m) mood modifier,(g) evaporates out of the fruit faster than water does.

11. Claim 9 where water content of said produce is substantially below their fresh state water level.

12. Claim 9 where said liquid evaporates out of the fruit faster than water does, and said container has sufficient space to allow said liquid to evaporate out of said mass and remains in the container, where said liquid in the mass is reduced to a desired level.

13. Claim 9 where most of any water in said produce is artificially induced and different from the water it had when harvested or picked.

14. Claim 9 where said mass is broken into chunks and said package is a wrapping.

15. Claim 14 where at least part of said wrap is edible.

16. Claim 8 with means to control liquid and moisture amounts in the container but outside the mass.

17. A mix, in retail ready packaging, of at least one produce chosen from fibrous, ready to eat, broken into particle size, chosen from grains, legumes and dried vegetables, which type is typically dry for storage, and at least one type of crushed fruit, said combination almost uniformly mixed, ratio of said dry produce to said fruit is such that water content of the fruit is comparable to that of dried version of same fruit, whereby said fruit is dried without dehydrating, whereby shelf life is comparable to dried fruit without use of damaging heat, costly vacuuming or loss of nutrients along with vaporized water and the mix is fulfilling, tasty, nutritional and easy to handle.

18. Claim 17 where said mixed combination is broken into wrapped chunks.

19. Claim 17 where said mixed combination is broken into wrapped chunks and said wrap is edible.

20. A method of producing fresh tasting and easy to handle fruits having the steps of:
Providing at least one type of dried produce from a list which includes at least fruits and vegetables,
Rehydrating said dried produce to a moisture level below that of same produce when fresh, and above said dried version, and enough for the taste of at least one of the rehydrated version of at least one of said produce is closer to fresh than dried version of same type, which rehydrating uses water below 50 degrees centigrade, which rehydrating uses water pressured below 3 atmospheres,
Packaging said rehydrated produce in retail packages.

21. Claim 20 where rehydration is by exposing said produce to a water state chosen from vapor and steam.

22. Claim 21 with means to maximize exposure to said vapor and or steam, which means include subjecting the produce to a number of actions chosen from a list that includes breaking into chunks, spinning, spreading at least across one tray, stacking said trays and supporting above a plane on tips of spikes based on said plane.

23. Claim 20 where said rehydrated produce is divided into hand holdable chunks, each chunk wrapped before packaging, which wrappings are peelable for consuming said rehydrated produce.

24. Claim 20 where said dried produce is wrapped in hand holdable chunks, each chunk wrapped before rehydrating, which wrappings are permeable to allow said rehydrating of the wrapped produce.

25. Claim 24 where a number of said wrapped chunks are placed in a retail container, which container has means to rehydrate said chunks it holds, which container can also serve as said retail package.

26. Claim 3 where said wrapping has 3 permeable layers, an inner layer one touching said produce, an outer layer touching the consumers hand holding the wrapping and a middle layer between the inner and outer layers, which middle layer has means to help prevent moisture transmission from the produce to users had, while all layers allow rehydration of the produce as wrapped.

27. Claim 24 where said middle layer is corrugated.

28. Claim 1 where said produce is fortified with at least one agent.
